(19) United States
(12) Patent Application Publication
(10) Pub. No.: US 2015/0239761 A1
(43) Pub. Date: Aug. 27, 2015

(54) RECOVERY OF RESOURCES FROM WASTE WATER

(71) Applicant: Daniel P. Smith, Tampa, FL (US)

(72) Inventor: Daniel P. Smith, Tampa, FL (US)

(21) Appl. No.: 14/190,266

(22) Filed: Feb. 26, 2014

(51) Int. Cl. C02F 3/28; C02F 1/42

(52) U.S. Cl. CPC C02F 3/2846; C02F 1/42

(57) ABSTRACT

The present invention relates to a method of recovering resources from waste water and especially to a method of recovering nitrogen from sanitation or sewage water. A multi-chamber ion exchange bioreactor is incorporated into a septic tank system which has an anaerobic treatment chamber therein having a solid blanket containing anaerobic bacteria therein, followed by a multi-chamber ion exchange bioreactor having a plurality of ion exchange chambers forming a serpentine passage having each upflow chamber followed by a downflow chamber for the removal of nitrogen compounds from the effluent passing therethrough.

### FIELD OF THE INVENTION

This invention relates to a method of recovering resources from water and especially to a method of recovering nitrogen from sanitation or sewage water.

### BACKGROUND OF THE INVENTION

Septic or on-site waste treatment systems are commonly used for the treatment of flowing wastewater or sewage from homes or small buildings. The sewage effluent includes solid matter when it enters a septic tank. Bacteria break down the solid matter collected in the septic tank to produce an output of treated effluent or grey water which is passed into a drain field for percolating into the soil. The effluent leaving the septic tank has most of the solids removed but still contains soluble nutrients, such as nitrogen and phosphate, therein which are leached into the soil where they can pollute underlying ground water and surface water such as lakes and streams and the like. Nitrogen and particularly nitrates move through the earth surface ground water and into lakes and streams. The nitrate ion (NO3−) contained in effluent is negatively charged and thus readily leachable.

Nitrates in the effluent can be transformed by nitrification and by denitrification. Nitrification is a process in which ammonium is oxidized and denitrification is a process in which nitrates are reduced back to a nitrogen gas before escaping into the air. Oxidized nitrogen (nitrate and nitrite) that is microbiologically reduced by denitrification under anaerobic conditions results in permanent removal of nitrates.

The Rose U.S. Pat. No. 6,531,063 teaches a zeolite bed leaching septic system and method for treating wastewater treatment for removal of nitrogen contaminants such as nitrates and ammonia from wastewater effluent. The system uses one or more zeolite tanks which contain regenerable, granulated zeolite materials to capture nitrogen contaminants from the septic tank effluent before the effluent flows into the drain field.

The Wanielista et al. U.S. Pat. No. 7,927,484 (and division U.S. Pat. No. 7,955,507) is for a waste water treatment system with a passive underground drain field for septic tank nutrient removal using functionalized green filtration media. A combination of recycled materials and natural sorption and filter media are used for removal of nutrients from septic tank effluent including phosphorus and nitrogen.

Other prior art U.S. patents include the Anderson U.S. Pat. No. 8,318,008 for a modular individual wastewater nutrient removal system and the Litz et al. U.S. Pat. Nos. 7,108,784 and 7,326,348 for an apparatus for removal and destruction of ammonia from an aqueous medium and the Williams et al. U.S. Pat. No. 7,326,347 for a dynamic up-flow zeolite system and method and U.S. Pat. No. 7,807,057 for the dynamic up-flow zeolite system and method and the Williams U.S. Pat. No. 7,390,414 for the regeneration of chemically treated zeolite. Also the Jowett U.S. Pat. No. 5,997,747 for the treatment of phosphorus in septic tank effluent and the Robertson U.S. Pat. No. 6,623,642 for a system for the removal of phosphorus from waste water and the Goto U.S. Pat. No. 5,106,405 for a horticultural medium consisting essentially of natural zeolite particles and the Breck U.S. Pat. No. 3,723,308 for a process for removal of ammonia from waste water streams and the Kiss et al. U.S. Pat. No. 4,772,307 for a process for preparing an agricultural fertilizer from sewage which incorporates zeolite.

The plurality of current onsite biological treatment systems for total nitrogen removal use an initial aerobic treatment followed 1. sequentially by denitrification, or 2. partially integrated with denitrification. These systems remove nitrogen by biological conversion to N₂ gas which exits to the atmosphere. The nitrogen is “destroyed”, in the sense that it is converted away from a molecular form directly useful as a plant nutrient (fertilizer).

The present invention is for a method of recovering nutrients and materials, especially nitrogen compounds, from sewage effluent to prevent the materials escaping into the environment and for productively using the materials recovered.

### SUMMARY OF THE INVENTION

This invention relates to a sewage treatment system for treating sewage effluent from a source of wastewater. A septic tank receives an input of untreated wastewater from a wastewater source and reduces solids in the wastewater to produce a clarified sewage effluent in an output therefrom. A multi-chambered ion exchange bioreactor has an input connected to the output from the septic tank for receiving the sewage effluent therefrom. An anaerobic treatment chamber or plurality of chambers therein has a solid blanket of sludge containing anaerobic bacteria and micro-organisms therein. The multi-chamber ion exchange bioreactor then has a plurality of ion exchange chambers following the anaerobic treatment chambers forming a serpentine passage with each upflow chamber followed by a downflow chamber for the removal of nitrogen compounds from the effluent passing therethrough. A drain field is connected to the output of the ion exchange bioreactor for the percolation of the treated effluent into the soil. Nitrogen compounds are thus captured in a multichamber ion exchange bioreactor for reuse.

### BRIEF DESCRIPTION OF THE DRAWINGS

The accompanying drawings, which are included to provide further understanding of the invention are incorporated in and constitute a part of the specification, and illustrate an embodiment of the invention and together with the description serve to explain the principles of the invention.

In the drawings:

FIG. 1 is a diagrammatic view of a septic tank sewage treatment system for a building having a nitrogen recovery system of the present invention;

FIG. 2 is a side sectional view of the nitrogen recovery module of FIG. 1;

FIG. 3 is a top plan view of one embodiment of a nitrogen recovery module of FIG. 1;

FIG. 4 is a top plan view of second embodiment of a nitrogen recovery module of FIG. 1; and

FIG. 5 is a top plan view of a third embodiment of a nitrogen recovery module of FIG. 1.

### DETAILED DESCRIPTION OF EXEMPLARY EMBODIMENT

In household wastewater or primary effluent (i.e. septic tank effluent), nitrogen is present predominantly in reduced nitrogen forms, i.e. as organic nitrogen and ammonium forms. Nitrate and nitrite are essentially not present. The present invention removes essentially all inorganic nitrogen and the majority of organic nitrogen from household wastewater in a manner that it can be reused in fertilizer or enriching the soil.

In household wastewater or primary effluent (i.e. septic tank effluent), nitrogen is present predominantly in reduced nitrogen forms, i.e. as organic nitrogen and ammonium forms. Nitrate and nitrite are essentially not present. Biochemical transformations of wastewater nitrogen is accomplished as follows:

Ammonification Conversion of Organic N to Ammonium Nitrogen:

Organic N->NH₄⁺—N

Nitritation (ammonium oxidation) Conversion of ammonium N to nitrite N:

NH₄⁺—N+1.5 0₂->NO₂⁻—N

Nitratation Conversion of nitrite N to nitrate N:

NO₂⁻—N+0.5 0₂->NO₃⁻—N

Nitrification Conversion of ammonium N to nitrate N:

NH₄⁺—N+2.0 0₂->NO₃⁻—N

Nitrification is two-step process of nitritation+nitratation. Nitrite often does not accumulate and nitrification is then considered a single process.

NH₄⁺—N+0₂->NO₃

Denitrification Conversion of oxidized nitrogen nitrate or nitrite) to N₂

NO₃⁻—N, NO₂⁻—N+CH₂O->N₂

Biological Nitrogen Removal is a two-step process in which:
Stage 1 is an aerobic process that requires oxygen (0₂) for ammonification nitrification to form NO₃ from organic N and ammonium.

Stage 2 is anoxic process that takes place in the absence of oxygen and uses an electron donor for denitrification to convert NO₃ to nitrogen gas.

Organic N→NH₄⁺→NO₂⁻→NO₃⁻→N₂

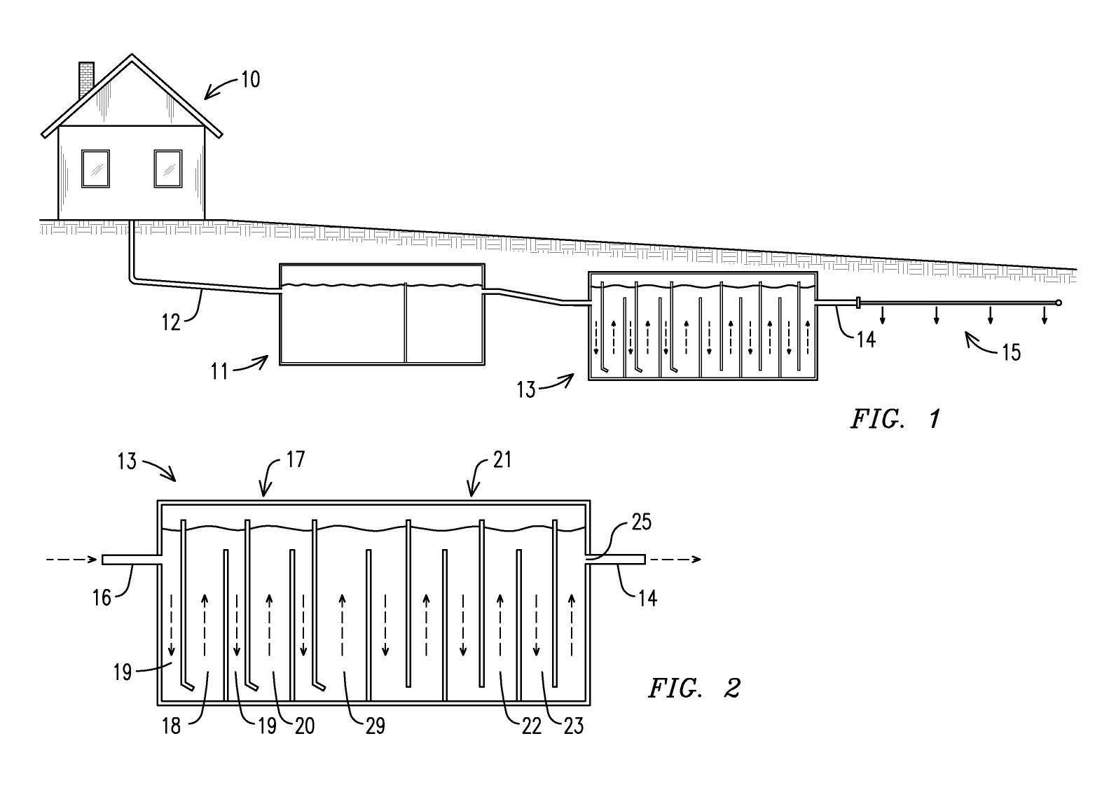

Referring to FIG. 1 of the drawings, a side elevation view of a septic tank sewage treatment system for a building 10 has a standard septic tank 11 connected from the building 10 by a sewage line 12. The septic tank provides a primary treatment of the waste entering the tank by capturing floating and settleable solids, and lowering the biological oxygen demand (BOD) by the biological treatment of solids in the waste water. The discharge from the septic tank 11 is a clarified waste water which is fed into a multi-chamber nitrogen removal module 13 where nitrogen compounds in the effluent is converted in form and captured for use in a nitrogen enriched material which can be used to enhance fertilizer or plant growth. The treated effluent free of nitrogen is fed out the output line 14 to the drain field 15 for percolation into the soil.

The multi-chamber nitrogen removal module 13, as more clearly seen in FIG. 2, has an input line 16 which is fed into an anaerobic biological reactor 17 which may include several chambers 18 and 20 forming either an upflow path or a downflow path or may have a serpentine path where the inflow is fed down a passageway 19 and then up through an anaerobic solid blanket. The effluent is then fed into another downflow passageway 19 and then up through another anaerobic solid blanket in chamber 20. The anaerobic chambers typically contain anaerobic sludge having a mixture of organic and inorganic components which includes bacteria and micro-organisms which act in the absence of oxygen. The nitrogen in the effluent is converted into forms which can be more easily and completed captured in the ion exchange chambers 21 so that the removal of the materials in the ion exchange chambers can be used in the enrichment of the soil for other plantings. The nitrogen is not loss to the atmosphere.

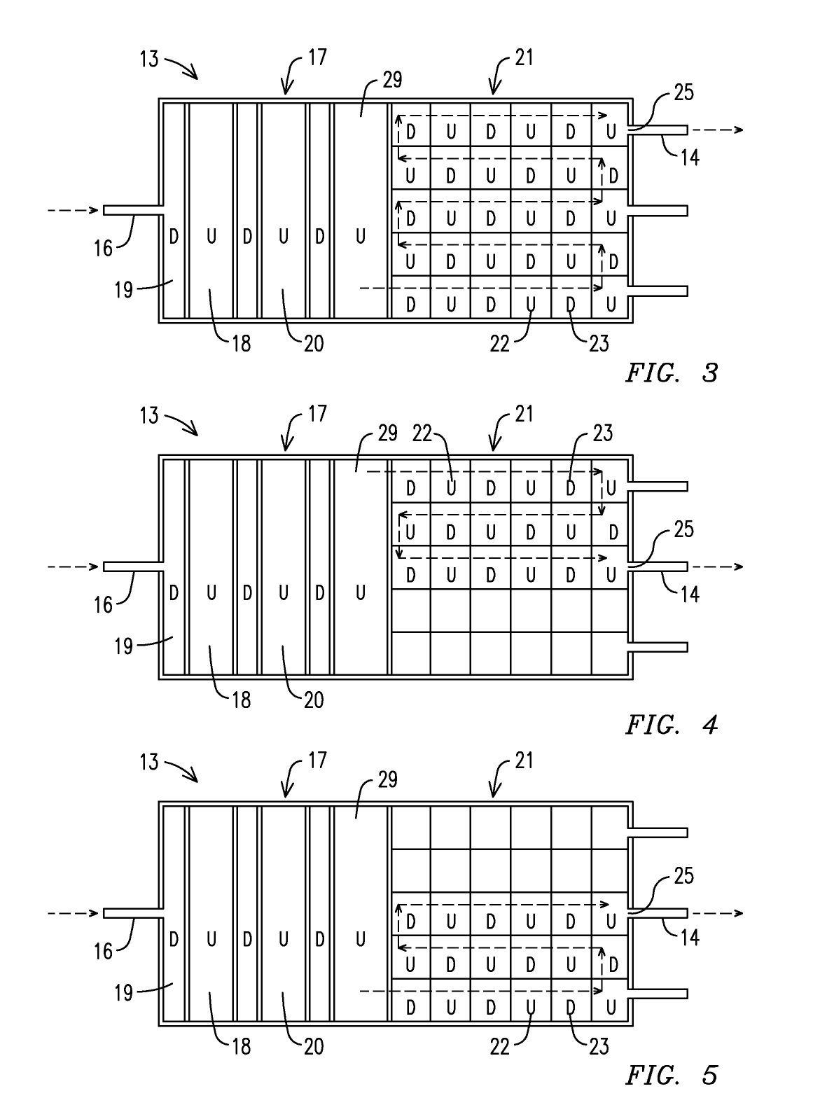

The ion exchange chambers 21 can be seen in FIG. 2 as forming a serpentine passageway in a series of upflow chambers 22, each upflow chamber followed by a downflow chamber 23 through multiple chambers which chambers are aligned in multiple parallel rows as seen in the top plan views of FIGS. 3 through 5.

The ion exchange materials media in each of the ion exchange chambers 21 is primarily a mineral ion exchange material using granular zeolite. Media may include Clinoptilolite, such as ZS403H, or Chabazite, such as ZS500H, from GSA Resources, Inc. Other granular Zeolites may also be used as a mineral in the ion exchangers and may contain more than one granular material.

In FIGS. 3 through 6, a series of plan views shows how the effluent is fed from line 16 from the septic tank into one end of the anaerobic bioreactor 17 and into the first downflow passageway 19 and up through the anaerobic biological reactor 17 chamber 18 and through another downflow passageway 19 and upflow chamber 20. The effluent is then fed by upflow through a granular expanded media chamber 29. This chamber provides additional polishing treatment of anaerobic chambers effluent before entry of wastewater into the ion exchange chambers. The anaerobic treated effluent is then fed into the serpentine ion exchange chambers 21 feeding from one upflow chamber 22 into one downflow chamber 23 down one row to the end of the row and then back through a parallel row and then back through another parallel row until the effluent reaches an output 25 and flows into the pipe 14 and drain field 15. The multiple parallel ion exchanger chambers fed serially in a serpentine pattern through the large number of chambers has proven more effective at removing the nitrogen compounds. Once the zeolite is exhausted from the capturing of nitrogen compounds, it is removed and used in fertilizer or to enrich plant growth. The operation modes of FIGS. 3, 4 and 5 use a different number of ion exchange chambers by connecting to a different one of the outlets 14 or by using a different point of entrance of wastewater into the ion exchange chamber 21.

The spent zeolite media after removal from the ion exchange chambers may include:
Direct application to agricultural soil which by incorporation into the soil increases water retention capacity of the soil, increases cation exchange capacity, and provides slow release fertilizer, all of which are beneficial to crop productivity and to the reduction of fertilizer cost or
Direct use of spent media without mixing into soil, for growth of edible and non-edible plants, such as controlled plant growth environments, greenhouses, growth of selected value added plants, etc. Spent media provides media with high water retention capacity, high cation exchange capacity, and slow release fertilizer, all of which are beneficial to crop productivity. Mixing of spent media with specific selected media without mixing into soil for growth of edible and non-edible plants, such as controlled plant growth environments, greenhouses, growth of selected value added plants, etc. Media mixture of spent zeolite+selected additive media provides media with high water retention capacity, high cation exchange capacity, and slow release fertilizer, all of which are beneficial to crop productivity.
The spent media may also be disposed of in landfills.

It should be clear at this time that a multi-chambered treatment and nitrogen recovery process has been provided for the treatment of sewage effluent. However the present invention is not to be considered limited to the forms shown which are to be considered illustrative rather than restrictive.

I claim:

1. A sewage treatment system comprising:
a source of wastewater;
a septic tank having an input of untreated wastewater from said source of wastewater for reducing solids therein to produce a clarified sewage effluent in an output therefrom;
a multi-chamber ion exchange bioreactor having an input connected to the output from said septic tank for receiving the sewage effluent therefrom, said multi-chamber ion exchange bioreactor having an anaerobic treatment chamber therein having a solid blanket containing anaerobic bacteria therein, said multi-chamber ion exchange bioreactor having a plurality of ion exchange chambers forming a serpentine passage having each upflow chamber followed by a downflow chamber for the removal of nitrogen compounds from said effluent passing therethrough from said anaerobic treatment chamber to an output therefrom;
a drain field connected to the output of said ion exchange bioreactor for percolating said treated effluent into the soil;
whereby nitrogen compounds are captured in a multichamber ion exchange bioreactor for reuse.

2. The sewage treatment system in accordance with claim 1 in which said plurality of ion exchange chambers includes a plurality of parallel rows of a plurality of ion exchange chambers, each row feeding into the next row until the effluent reaches the output from said multi-chamber ion exchange bioreactor.

3. The sewage treatment system in accordance with claim 2 in which each of said plurality of ion exchange chambers is filled with a granular ion exchange material.

4. The sewage treatment system in accordance with claim 3 in which the granular ion exchange material includes zeolite.

5. The sewage treatment system in accordance with claim 4 in which the granular ion exchange material is clinoptilolite.

6. The sewage treatment system in accordance with claim 5 in which the granular ion exchange material is chabazite.

7. The sewage treatment system in accordance with claim 6 in which said multi-chamber ion exchange bioreactor has a plurality of outputs each aligned with one end of a plurality of rows of ion exchange chambers.

8. The sewage treatment system in accordance with claim 7 in which each of said plurality of parallel rows of ion exchange chambers has at least four ion exchange chambers.

9. The sewage treatment system in accordance with claim 7 in which each of said plurality of parallel rows of ion exchange chambers has six ion exchange chambers.

10. The sewage treatment system in accordance with claim 2 having a plurality of anaerobic treatment chambers therein having a solid blanket containing anaerobic bacteria in each one therein.

11. The sewage treatment system in accordance with claim 10 having two anaerobic treatment chambers therein having a solid blanket containing anaerobic bacteria in each one therein.

12. The sewage treatment system in accordance with claim 11 having a granular expanded media chamber following said two anaerobic treatment chambers.

13. The sewage treatment system in accordance with claim 10 having a plurality of passageways extending parallel to each anaerobic treatment chamber, each passageway directing effluent downward to below the adjacent anaerobic treatment chamber for the effluent to pass upward through said anaerobic treatment chamber.

14. The sewage treatment system accordance with claim 13 in which said plurality of passageways and plurality of anaerobic treatment chambers forms a serpentine flow pattern of effluent through said anaerobic treatment chambers.

15. A method of treating sewage including the steps of;
selecting a septic tank system having an input of untreated wastewater from a source of wastewater for reducing solids therein to produce a clarified sewage effluent in an output therefrom;
selecting a multi-chamber ion exchange bioreactor having an input connected to the output from said selected septic tank for receiving the sewage effluent therefrom, said multi-chamber ion exchange bioreactor having an anaerobic treatment chamber therein having a solid blanket containing anaerobic bacteria therein, and said multi-chamber ion exchange bioreactor having a plurality of ion exchange chambers forming a serpentine passage having each upflow chamber followed by a downflow chamber for the removal of nitrogen compounds from said effluent passing therethrough from said anaerobic treatment chamber to an output therefrom;
a drain field connected to the output of said ion exchange bioreactor for percolating said treated effluent into the soil;
passing waste water from said waste water source into said septic tank system and through said anaerobic treatment chamber and through said multi-chamber ion exchange bioreactor for removing nitrogen compounds from said effluent; and
percolating said treated effluent from said multi-chamber ion exchange bioreactor into soil;
whereby nitrogen compounds are captured in a multichamber ion exchange bioreactor for reuse.
